(19) United States
(12) Patent Application Publication
(10) Pub. No.: US 2015/0168739 A1
(43) Pub. Date: Jun. 18, 2015

(54) IMAGE STABILIZER, CAMERA SYSTEM, AND IMAGING METHOD

(71) Applicant: Kabushiki Kaisha Toshiba, Minato-ku (JP)

(72) Inventors: Takayuki Ogasahara, Yokohama (JP); Katsuo Iwata, Yokohama (JP); Kazuhiro Nagata, Yokohama (JP); Ninao Sato, Mitaka (JP)

(73) Assignee: Kabushiki Kaisha Toshiba, Minato-ku (JP)

(21) Appl. No.: 14/471,428

(22) Filed: Aug. 28, 2014

(30) Foreign Application Priority Data
Dec. 13, 2013 (JP) 2013-258087

(51) Int. Cl. G02B 27/64; H04N 5/369; H04N 5/232

(52) U.S. Cl. CPC G02B 27/646; H04N 5/23287; H04N 5/369

(57) ABSTRACT

According to one embodiment, an image stabilizer includes a lens drive controller. The lens drive controller performs a first control and a second control. The lens drive controller controls the driving of a correction lens according to the amount of shake in the first control. In the second control, the lens drive controller controls the driving of the correction lens so that a first area is in focus and a second area is not in focus.

### CROSS-REFERENCE TO RELATED APPLICATIONS

This application is based upon and claims the benefit of priority from Japanese Patent Application No. 2013-258087, filed on Dec. 13, 2013; the entire contents of which are incorporated herein by reference.

### FIELD

Embodiments described herein relate generally to an image stabilizer, a camera system, and an imaging method.

### BACKGROUND

In the past, a method of intentionally blurring a part of an image has been known as a method of showing an image. According to this method, an effect of making an object stand out against the background is obtained by making the object be in focus and blurring the background. An effect of improving a viewing property of an image is obtained by intentionally blurring an arbitrary portion of the image. A camera system requires easily realizing this method of showing an image when taking an image.

Since a lens having a low F number is mounted as an imaging optical system, a camera system can take an image in which an object is in focus and the background is blurred. Since the depth of field of the camera system is reduced when the camera system uses a lens having a low F number, the camera system cannot easily perform focusing. The camera system cannot easily perform focusing when taking a video.

The camera system may introduce a lens having a large depth of field or an adjustable diaphragm, in order to easily perform focusing. Since the structure of the camera system is complicated in this case, manufacturing cost is increased and the thickness of the camera system is increased.

### BRIEF DESCRIPTION OF THE DRAWINGS

FIG. 1 is a block diagram illustrating the schematic configuration of a camera system that includes an image stabilizer according to an embodiment;

FIG. 2 is a block diagram illustrating the schematic configuration of a solid-state imaging device;

FIG. 3 is a diagram illustrating the schematic configuration of an optical system that is included in a camera system;

FIG. 4 is a diagram illustrating an example of a positional relationship between a correction lens and an image sensor in a normal photographing mode;

FIG. 5 is a diagram illustrating an example of a positional relationship between the correction lens and the image sensor in a blurring adjustment mode;

FIG. 6 is a diagram explaining focus adjustment when a positional relationship between the correction lens and the image sensor is in a state illustrated in FIG. 4;

FIG. 7 is a diagram explaining focus adjustment when a positional relationship between the correction lens and the image sensor is in a state illustrated in FIG. 5;

FIG. 8 is a diagram illustrating an example of an image that is obtained in the blurring adjustment mode; and

FIG. 9 is a diagram illustrating an example of a positional relationship between a correction lens and an image sensor of a modification of the embodiment.

### DETAILED DESCRIPTION

In general, according to one embodiment, an image stabilizer includes a lens drive controller. The lens drive controller controls the driving of a correction lens according to the amount of shake when an object image is captured. The correction lens is built in an imaging optical system. The lens drive controller performs a first control and a second control. The lens drive controller controls the driving of the correction lens according to the amount of shake in the first control. In the second control, the lens drive controller controls the driving of the correction lens so that a first area is in focus and a second area is not in focus. The first area is a part of an imaging area that receives the object image. The second area is a portion of the imaging area except for the first area.

Exemplary embodiments of an image stabilizer, a camera system, and an imaging method will be explained below in detail with reference to the accompanying drawings. The present invention is not limited to the following embodiments.

### Embodiment

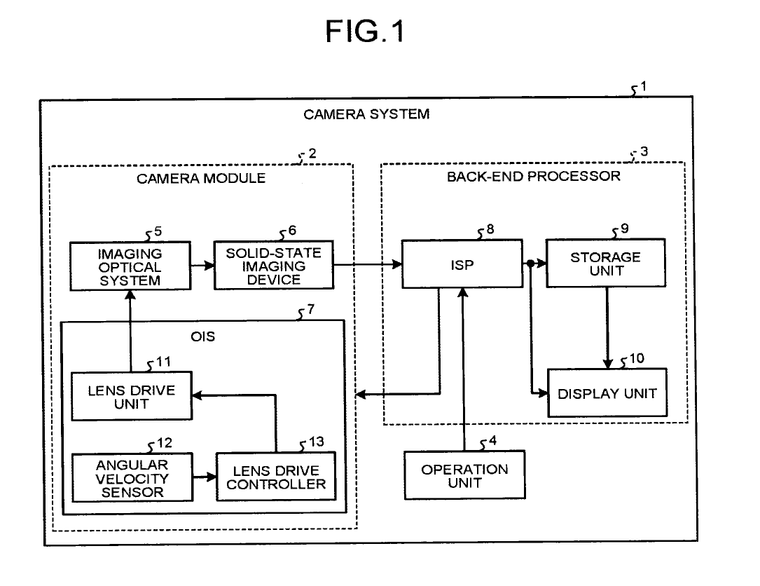

FIG. 1 is a block diagram illustrating the schematic configuration of a camera system that includes an image stabilizer according to an embodiment. The camera system 1 is, for example, a digital camera. The camera system 1 may be any one of a digital still camera and a digital video camera. The camera system 1 may be an electronic device including a camera module 2 (for example, a portable terminal with a camera) or the like.

The camera system 1 includes a camera module 2, a back-end processor 3, and an operation unit 4. The camera module 2 includes an imaging optical system 5, a solid-state imaging device 6, and an optical image stabilizer (OIS) 7. The back-end processor 3 includes an image signal processor (ISP) 8, a storage unit 9, and a display unit 10.

The imaging optical system 5 receives light from an object and forms an object image. The solid-state imaging device 6 takes the object image. The OIS 7 performs the stabilization of the object image. The OIS 7 includes a lens drive unit 11, an angular velocity sensor 12, and a lens drive controller 13.

The angular velocity sensor 12 detects a moving direction and a moving distance (the amount of shake) of the camera system 1 that are caused by shake. The angular velocity sensor 12 includes, for example, a vibration gyro-mechanism. The lens drive controller 13 controls the driving of a correction lens that is performed by the lens drive unit 11. The lens drive unit 11 drives the correction lens according to the control of the lens drive controller 13. The lens drive unit 11 includes, for example, a voice coil motor. The correction lens is built in the imaging optical system 5. The OIS 7 drives the correction lens in the stabilization of the object image.

The ISP 8 processes image signals that are obtained by the imaging of the solid-state imaging device 6. The storage unit 9 stores the image that has been subjected to the signal processing performed by the ISP 8. The storage unit 9 outputs image signals to the display unit 10 according to the operation of a user or the like.

The display unit 10 displays an image according to image signals that are input from the ISP 8 or the storage unit 9. The display unit 10 is, for example, a liquid crystal display. The camera system 1 performs the feedback control of the camera module 2 on the basis of data that have been subjected to the signal processing performed by the ISP 8.

The operation unit 4 includes various operation buttons that receive an input operation performed by a user. The operation unit 4 outputs information, which corresponds to the input operation, to the ISP 8. The ISP 8 controls the camera module 2 and the back-end processor 3 according to the information that is output from the operation unit 4.

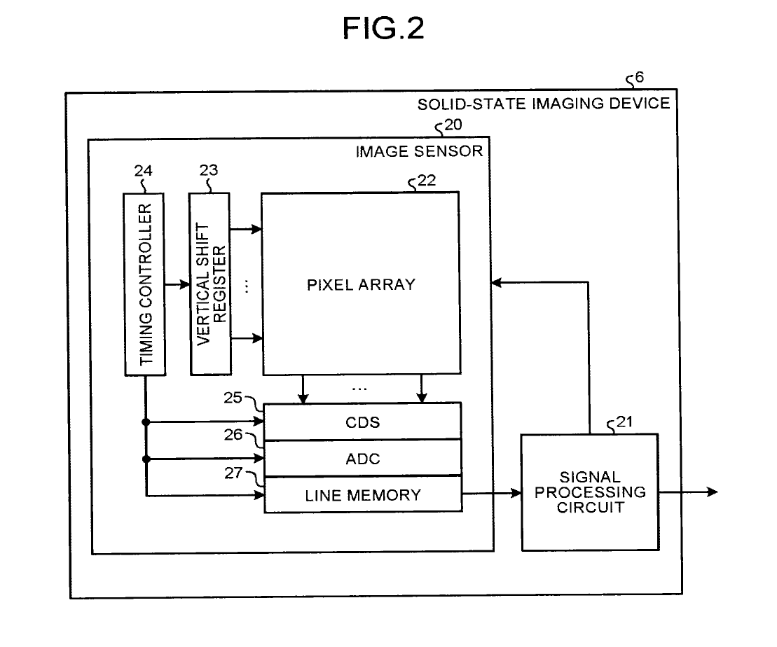

FIG. 2 is a block diagram illustrating the schematic configuration of the solid-state imaging device. The solid-state imaging device 6 includes an image sensor 20 that is an imaging element and a signal processing circuit 21 that is an image processing unit. The image sensor 20 is, for example, a CMOS image sensor. The image sensor 20 may be a CCD other than the CMOS image sensor.

The image sensor 20 includes a pixel array 22, a vertical shift register 23, a timing controller 24, a correlation double sampling unit (CDS) 25, an analog-digital converter (ADC) 26, and a line memory 27.

The pixel array 22 is formed of a plurality of pixels that are disposed in the form of an array in a horizontal direction (row direction) and a vertical direction (column direction). Each of the pixels includes a photodiode that is a photoelectric conversion element. The pixel array 22 generates signal charges corresponding to the amount of light incident on each pixel.

The timing controller 24 supplies a vertical synchronization signal, which indicates timing where a signal output from each pixel of the pixel array 22 is read out, to the vertical shift register 23. The timing controller 24 supplies a timing signal, which indicates drive timing, to each of the CDS 25, the ADC 26, and the line memory 27.

The vertical shift register 23 selects the pixels of the pixel array 22 for each row according to the vertical synchronization signal supplied from the timing controller 24. The vertical shift register 23 outputs a readout signal to each pixel of the selected row. The pixel to which the readout signal is input from the vertical shift register 23 outputs signal charges that are accumulated according to the amount of incident light. The pixel array 22 outputs the signals, which are output from the pixels, to the CDS 25 through a vertical signal line.

The CDS 25 performs correlation double sampling processing, which reduces fixed pattern noise, on the signals output from the pixel array 22. The ADC 26 converts an analog signal into a digital signal. The line memory 27 accumulates signals that are output from the ADC 26. The image sensor 20 outputs the signals that are accumulated in the line memory 27.

The signal processing circuit 21 performs various kinds of signal processing on the image signals that are output from the image sensor 20. The signal processing circuit 21 performs, for example, defect correction, gamma correction, noise reduction processing, lens shading correction, white balance adjustment, distortion correction, resolution restoration, and the like as the various kinds of signal processing.

The solid-state imaging device 6 outputs the image signals, which has been subjected to the signal processing performed by the signal processing circuit 21, to the outside of a chip. The solid-state imaging device 6 performs the feedback control of the image sensor 20 on the basis of data that have been subjected to the signal processing performed by the signal processing circuit 21.

In the camera system 1, at least one of the various kinds of signal processing that are performed in this embodiment by the signal processing circuit 21 may be performed by the ISP 8 of the back-end processor 3. In the camera system 1, at least one of the various kinds of signal processing may be performed by both the signal processing circuit 21 and the ISP 8. The signal processing circuit 21 and the ISP 8 may additionally perform signal processing other than the signal processing described in this embodiment.

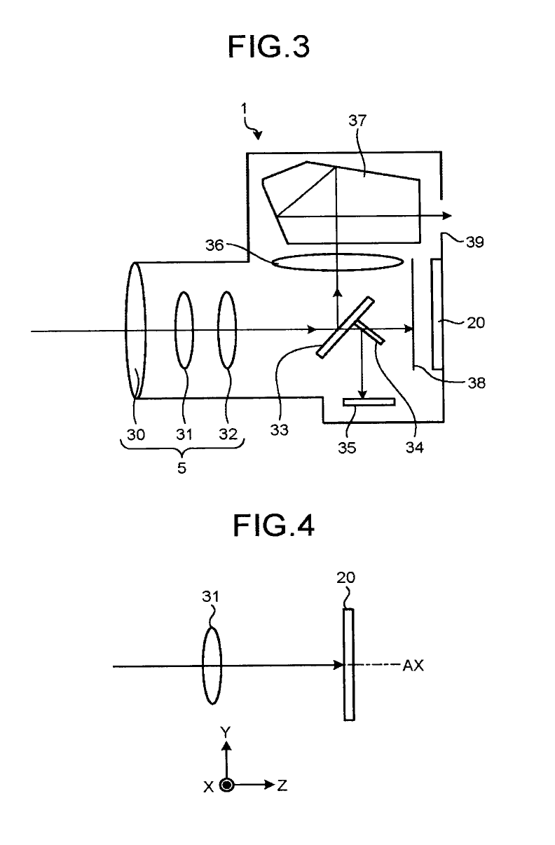

FIG. 3 is a diagram illustrating the schematic configuration of the optical system that is included in the camera system. An imaging lens 30, a correction lens 31, and an imaging lens 32 form the imaging optical system 5. The lens drive unit 11 drives the correction lens 31 that is built in the imaging optical system 5. Meanwhile, the imaging optical system 5 has only to include the correction lens 31 that is driven by the lens drive unit 11, and the configuration of the imaging optical system 5 is arbitrary.

Light, which is incident on the imaging optical system 5 from an object, is incident on a main mirror 33 through the imaging optical system 5. Light, which has passed through the main mirror 33, is incident on a sub-mirror 34. Light, which has passed through the sub-mirror 34 and a mechanical shutter 38, is incident on the image sensor 20.

Light, which is reflected by the sub-mirror 34, travels to an autofocus (AF) sensor 35. The camera system 1 performs focus adjustment that uses a detection result of the AF sensor 35. Light, which is reflected by the main mirror 33, travels to a finder 39 through a lens 36 and a prism 37. The optical system, which is included in the camera system 1, is not limited to the optical system described in the embodiment, and may be appropriately modified. The correction lens 31 may be disposed at any position on a path along which light reflected from an object travels to the image sensor 20. Further, the number of correction lenses 31, which can be driven by the OIS 7, is arbitrary.

Next, the control of the driving of the correction lens 31, which is performed by the OIS 7, will be described. The lens drive controller 13 performs a first control and a second control in the driving of the correction lens 31.

The lens drive controller 13 controls the driving of the correction lens 31 according to the amount of shake at the time of taking an object image, as the first control. The lens drive controller 13 receives the amount of shake, which is detected by the angular velocity sensor 12 at the time of taking the object image, from the angular velocity sensor 12. The lens drive controller 13 calculates the moving direction and a moving distance of the correction lens 31 that allow the received amount of shake to be cancelled out. The lens drive controller 13 generates a control signal that is used to drive the correction lens 31 in the calculated moving direction and moving distance.

The lens drive unit 11 drives the correction lens 31 according to the control signal that is generated by the lens drive controller 13. Accordingly, the camera system 1 can obtain an image from which an influence of the shake has been reduced.

The lens drive controller 13 controls the driving of the correction lens 31 so that a first area is in focus and a second area is not in focus, as the second control. The first area is a part of an imaging area that is received as an image by the solid-state imaging device 6. The second area is a portion of the imaging area other than the first area.

For example, the camera module 2 is switched to a normal photographing mode and a blurring adjustment mode to be capable of taking an object image. The blurring adjustment mode is a mode in which focus adjustment is performed in the first and second areas by the second control performed on the correction lens 31. The normal photographing mode is a mode at the time except for the time when the blurring adjustment mode is selected. The camera module 2 can perform the stabilization of en image, which is performed by the first control performed on the correction lens 31, in the normal photographing mode. The lens drive controller 13 can switch the control of the driving of the correction lens 31 to the first control and the second control.

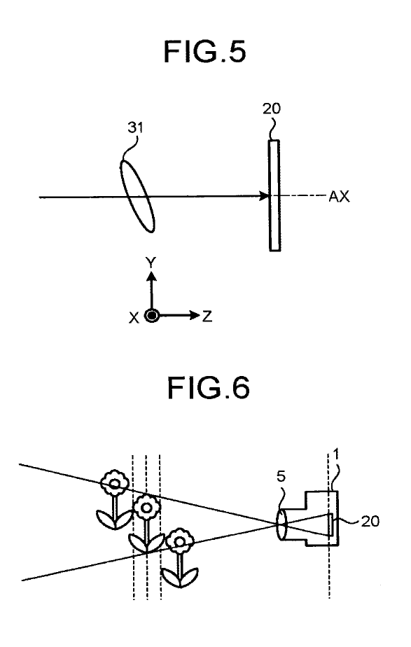

FIG. 4 is a diagram illustrating an example of a positional relationship between the correction lens and the image sensor in the normal photographing mode. FIG. 5 is a diagram illustrating an example of a positional relationship between the correction lens and the image sensor in the blurring adjustment mode.

In the normal photographing mode shown in FIG. 4, the correction lens 31 is disposed so that, for example, the center of the correction lens 31 is positioned on an optical axis AX of the imaging optical system 5. Further, the correction lens 31 is disposed perpendicular to the optical axis AX. A Z axis is an axis parallel to the optical axis AX. An X axis and a Y axis are axes that are perpendicular to each other and are perpendicular to the Z axis.

FIG. 6 is a diagram illustrating focus adjustment when a positional relationship between the correction lens and the image sensor is in a state illustrated in FIG. 4. The camera module 2 appropriately performs focus adjustment over the entire imaging area. The solid-state imaging device 6 receives an image that has been subjected to focus adjustment corresponding to a distance between the camera system 1 and an object over the entire imaging area.

For example, when focus adjustment has been performed on a certain object, the solid-state imaging device 6 can obtain an image in which an object present in the range of a distance corresponding to the depth of field of the imaging optical system 5 from the object seems to be in focus. When the stabilization of an image is to be performed, the lens drive controller 13 controls the driving of the correction lens 31 according to the amount of shake of the camera system 1.

In the blurring adjustment mode illustrated in FIG. 5, the lens drive controller 13 adjusts the inclination of the correction lens 31 with respect to the optical axis AX, as the second control. For example, the inclination of the correction lens 31 illustrated in FIG. 5 is adjusted from the state illustrated in FIG. 4 so that an end portion of the correction lens 31 corresponding to the positive side in a Y direction is moved in a negative Z direction. The lens drive controller 13 allows the first area to be in focus and intentionally allows the second area not to be in focus by adjusting the inclination of the correction lens 31. Meanwhile, the lens drive controller 13 may incline the correction lens 31 to any side, and also can appropriately adjust the degree of inclination of the correction lens 31.

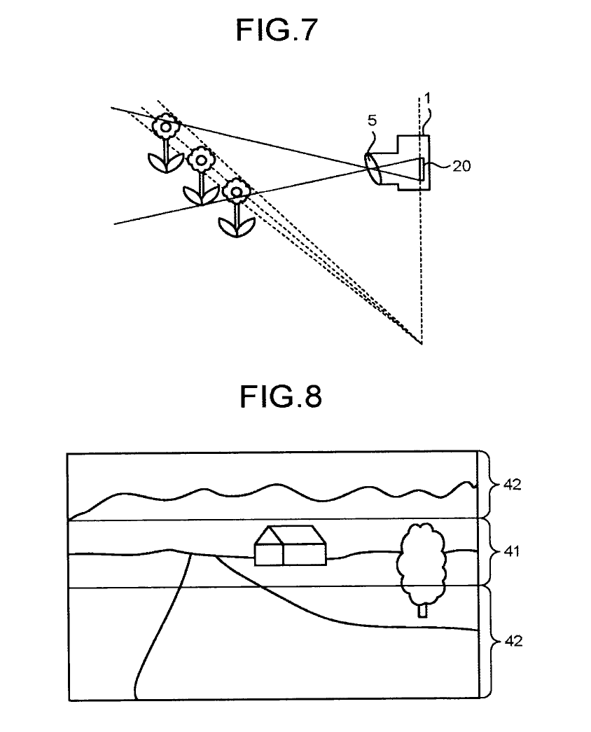

FIG. 7 is a diagram illustrating focus adjustment when a positional relationship between the correction lens and the image sensor is in a state illustrated in FIG. 5. The solid-state imaging device 6 obtains an image in which an object present in a first area is in focus and the entire second area is blurred, regardless of a distance between the camera system 1 and an object.

For example, a user designates a portion, in which an object on which the user wants to focus the correction lens 31 is present, of an imaging area as the first area. For example, the operation unit 4 receives an input operation of a user that designates the first area. The operation unit 4 sends an instruction, which corresponds to the input operation, to the ISP 8. The ISP 8 sends the instruction, which is sent from the operation unit 4, to the lens drive controller 13 that is provided in the camera module 2.

The camera system 1 may make the display unit 10 function as a liquid crystal finder and may make a touch sensor, which is provided on the display unit 10, function as the operation unit 4. For example, a user designates the first area by touching the display unit 10 that displays the imaging area. The camera system 1 may include any input means other than the touch sensor as the operation unit 4.

When the lens drive controller 13 receives an instruction, which designates the first area from the imaging area, from the ISP 8, the lens drive controller 13 performs the second control according to the instruction. The lens drive controller 13 adjusts the inclination of the correction lens 31 so that the correction lens 31 focuses on the portion of the imaging area designated as the first area and does not focus on the second area, which is a portion except for the portion designated as the first area.

While the blurring adjustment mode is designated, the lens drive controller 13 adjusts the inclination of the correction lens 31 according to the instruction that designates the first area. When the change of a mode to the normal photographing mode from the blurring adjustment mode is instructed, the lens drive controller 13 returns the inclined correction lens 31 so that, for example, the correction lens 31 is perpendicular to the optical axis AX. When the stabilization of an image is instructed to be performed at the time of the change of a mode, the lens drive controller 13 controls the driving of the correction lens 31 according to the amount of shake by the first control.

Meanwhile, the operation unit 4 may be capable of receiving an input operation for designating the second area. In this case, when the lens drive controller 13 receives an instruction, which designates the second area from the imaging area, from the ISP 8, the lens drive controller 13 performs the second control according to the instruction. The lens drive controller 13 adjusts the inclination of the correction lens 31 so that the correction lens 31 does not focus on the portion of the imaging area designated as the second area and focuses on the first area, which is a portion other than the portion designated as the second area.

The camera system 1 may set the first area or the second area by any means other than an operation that is input to the operation unit 4 by a user. Even when the first area or the second area is set by any means, the lens drive controller 13 can perform the second control according to such setting.

FIG. 8 is a diagram illustrating an example of an image that is obtained in the blurring adjustment mode. When the lens drive unit 11 drives the correction lens 31 according to the second control performed by the lens drive controller 13, the camera module 2 focuses on a first area 41 and does not focus on second areas 42. The camera module 2 focuses on at least any object, which is included in the first area 41, by the second control. Further, the camera module 2 does not focus on all objects that are included in the second areas 42.

In the example illustrated in FIG. 8, the shape of the first area 41 is set to the shape of, for example, a belt of which the longitudinal direction is a horizontal direction. The second areas 42 are set above and below the first area 41, respectively. The camera module 2 can arbitrarily change the range of the first area 41 and the range of the second areas 42 according to the control of the inclination of the correction lens 31 that is performed by the lens drive controller 13. A user can obtain an image in which a desired portion is in focus and the other portions are intentionally blurred.

According to the embodiment, the OIS 7 controls the driving of the correction lens 31 so that the first area is in focus and the second areas are not in focus, as the second control. The camera module 2 can realize photographing that is performed by a method of intentionally blurring a part of the imaging area. The camera module 2 can obtain an image, which includes a focused portion and blurred portions, by one time of imaging without composing images that are separately taken two more times.

The camera module 2 uses the OIS 7, which stabilizes an image, in a method of intentionally blurring a part of the imaging area. The camera module 2 can easily make an image be partially cut of focus by using the imaging optical system 5, which has the same configuration as the configuration in the related art, even though a special optical system that makes an image be partially out of focus is riot prepared. The camera module 2 does not require the addition of the new structure, which intentionally blurs an arbitrary portion of an image, or the complication of the structure. The camera system 1 can be formed to have the configuration that is suitable for the reduction in size and thickness. The camera system 1 can suppress an increase in manufacturing cost.

Accordingly, the camera system 1 can achieve the taking of an image, of which a part of an imaging area is intentionally blurred, by structure that is simple and has low manufacturing cost. The camera system 1 can obtain an effect of making an object stand out against the background, an effect of improving a viewing property of an image, and the like, by intentionally blurring an arbitrary portion of an image. The camera system 1 can take an image, which has high visual performance, by a simple operation for changing the inclination of the correction lens 31.

The lens drive controller 13 can switch the control of the driving of the correction lens 31 to the first control and the second control. The OIS 7 can provide a function of stabilizing an image and a function of blurring a part of an imaging area. The camera system 1 can switch the function of the OIS 7 to the stabilization of an image in the normal photographing mode and the adjustment of blurring in the blurring adjustment mode to take an image.

The lens drive controller 13 is not limited to a controller, which adjusts the inclination of the correction lens 31 with respect to the optical axis AX, in the second control. As long as the lens drive controller 13 can intentionally blur a part of the imaging area, the lens drive controller 13 may drive the correction lens 31 in any manner. For example, the lens drive controller 13 may drive the correction lens 31 in any direction parallel to a predetermined plane.

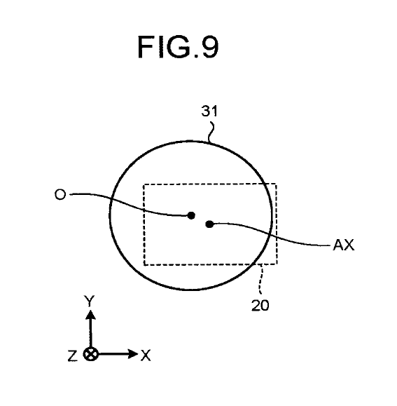

FIG. 9 is a diagram illustrating an example of a positional relationship between a correction lens and an image sensor of a modification of the embodiment. In the second control, the lens drive controller 13 adjusts the position of the correction lens 31 in a direction of an XY-plane. The XY-plane is a plane perpendicular to the optical axis AX.

The lens drive controller 13 moves the correction lens 31 so that the center O of a correction lens 31 is shifted to any position present in an MY-plane from a position present on an optical axis AX. For example, the correction lens 31 illustrated in FIG. 9 is obliquely moved in a negative X direction and a positive Y direction from a state in which the center O is positioned on the optical axis AX. The lens drive controller 13 may move the correction lens 31 in any one direction of an X direction and a Y direction. The lens drive controller 13 may incline the correction lens 31 to any side on an XY-plane, and also can appropriately adjust the moving distance of the correction lens 31.

Even in this modification, the camera system 1 can achieve the taking of an image, of which a part of an imaging area is intentionally blurred, by structure that is simple and has low manufacturing cost. The camera system 1 can take an image, which has high visual performance, by a simple operation for changing the position of the correction lens 31 in a direction of a plane perpendicular to the optical axis AX.

The OIS 7 can provide a function of stabilizing an image and a function of blurring a part of an imaging area. The camera system 1 can switch the function of the OIS 7 to the stabilization of an image in the normal photographing mode and the adjustment of blurring in the blurring adjustment mode to take an image. Meanwhile, the lens drive controller 13 may move the correction lens 31 in the direction of the XY-plane, and also may adjust the inclination of the correction lens 31 as in the case illustrated in FIG. 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image stabilizer comprising:
a lens drive controller configured to control the driving of a correction lens, which is built in an imaging optical system, according to an amount of shake when an object image is captured,
wherein the lens drive controller performs a first control to control the driving of the correction lens according to the amount of shake, and a second control to control the driving of the correction lens so that a first area is in focus and a second area is not in focus,
the first area is a part of an imaging area that receives the object image, and
the second area is a portion of the imaging area other than the first area.

2. The image stabilizer according to claim 1,
wherein in the second control, the lens drive controller adjusts the inclination of the correction lens with respect to an optical axis of the imaging optical system.

3. The image stabilizer according to claim 1,
wherein in the second control, the lens drive controller adjusts a position of the correction lens in a direction of a plane perpendicular to an optical axis of the imaging optical system.

4. The image stabilizer according to claim 1,
wherein in the second control, the lens drive controller adjusts the inclination of the correction lens with respect to an optical axis of the imaging optical system and a position of the correction lens in a direction of a plane perpendicular to the optical axis.

5. The image stabilizer according to claim 1,
wherein the lens drive controller performs the second control according to an instruction that sets the first area or the second area from the imaging area.

6. The image stabilizer according to claim 1,
wherein the control of the driving of the correction lens is switchable to the first control and the second control by the lens drive controller.

7. A camera system comprising:
a camera module; and
a processor configured to control the camera module,
wherein the camera module includes
an imaging optical system configured to receive light from an object and to form an object image,
an image stabilizer configured to perform stabilization of the object image, and
a solid-state imaging device configured to capture the object image,
a correction lens, which is driven when the image stabilizer performs the stabilization of the object image, is built in the imaging optical system,
the image stabilizer includes a lens drive controller that controls the driving of the correction lens according to an amount of shake at the time of capturing the object image,
the lens drive controller performs a first control to control the driving of the correction lens according to the amount of shake, and a second control to control the driving of the correction lens so that a first area is in focus and a second area is not in focus,
the first area is a part of an imaging area that receives the object image, and
the second area is a portion of the imaging area other than the first area.

8. The camera system according to claim 7, further comprising:
an operation unit configured to receive an input operation for designating the first area or the second area and sends an instruction, which corresponds to the input operation, to the processor,
wherein the processor sends the instruction, which is sent from the operation unit, to the lens drive controller.

9. The camera system according to claim 8,
wherein the control of the driving of the correction lens is switchable to the first control and the second control according to the instruction by the lens drive controller.

10. The camera system according to claim 7,
wherein in the second control, the lens drive controller adjusts the inclination of the correction lens with respect to an optical axis of the imaging optical system.

11. The camera system according to claim 7,
wherein in the second control, the lens drive controller adjusts a position of the correction lens in a direction of a plane perpendicular to an optical axis of the imaging optical system.

12. The camera system according to claim 7,
wherein in the second control, the lens drive controller adjusts the inclination of the correction lens with respect to an optical axis of the imaging optical system and a position of the correction lens in a direction of a plane perpendicular to the optical axis.

13. An imaging method comprising:
receiving light from an object;
forming an object image;
performing stabilization of the object image; and
capturing the object image,
wherein a first control and a second control are performed,
the first control is performed to control the driving of a correction lens built in an imaging optical system according to an amount of shake at the time of capturing the object image,
the second control is performed to control the driving of the correction lens so that a first area is in focus and a second area is not in focus,
the first area is a part of an imaging area that receives the object image, and
the second area is a portion of the imaging area other than the first area.

14. The imaging method according to claim 13,
wherein the inclination of the correction lens with respect to an optical axis of the imaging optical system is adjusted in the second control.

15. The imaging method according to claim 13,
wherein a position of the correction lens in a direction of a plane perpendicular to an optical axis of the imaging optical system is adjusted in the second control.

16. The imaging method according to claim 13,
wherein the inclination of the correction lens with respect to an optical axis of the imaging optical system and a position of the correction lens in a direction of a plane perpendicular to the optical axis are adjusted in the second control.

17. The imaging method according to claim 13,
wherein the control of the driving of the correction lens is switchable to the first control and the second control.

18. The imaging method according to claim 13, further comprising:
receiving an input operation for designating the first area or the second area; and
performing the second control according to an instruction that corresponds to the input operation.
